(19) United States
(12) Patent Application Publication
(10) Pub. No.: US 2017/0305759 A1
(43) Pub. Date: Oct. 26, 2017

(54) WATER TREATMENT METHOD AND SYSTEM PROVIDING PARTIAL DYNAMIC BY-PASS OF WATER TREATMENT STAGES

(71) Applicant: Localized Water Solutions LLC, Austin, TX (US)

(72) Inventors: Uri Braun, Cambridge, MA (US); Joseph Saugrain Lamy, Austin, TX (US)

(21) Appl. No.: 15/136,369

(22) Filed: Apr. 22, 2016

(51) Int. Cl. C02F 1/00; G05D 7/06

(52) U.S. Cl. CPC C02F 1/008; G05D 7/0635; C02F 2301/043; C02F 2209/006; C02F 2303/04

(57) ABSTRACT

Embodiments of the present invention are directed to water treatment systems and methods offering improved efficiency, longevity and versatility. More specifically, water treatment systems and methods configured in accordance with the present invention provide for dynamic bypass of one or more water treatment stages by at least a portion of water being treated. Dynamic bypass reduces the amount of work expended by water treatment system components to treat a given volume of water. Thus, by adjusting such work expended based on a target water quality, the water treatment system can conserve power, extend system up-time, reduce usage of system consumables, potentially remediate a fault in a treatment stage under certain conditions, avoid the need for designing different systems for different conditions, and support automation of system operation.

### FIELD OF THE DISCLOSURE

The disclosures made herein relate generally to water treatment methods and systems and, more particularly, to water treatment methods and systems configured for providing partial dynamic by-pass of water treatment stages.

### BACKGROUND

In various industries and applications, there is often a need for treated water meeting suitable water quality criteria for consumption and/or industrial use. However, available sources of water can suffer from any number of water quality considerations that can preclude its use for human consumption and/or industrial use. Examples of such water quality considerations include, but are not limited to, bulk contaminants (e.g., biological matter such as plant matter), mineral inclusion (e.g., salt), presencet of microorganisms (e.g., bacteria, virus, cysts, protozoa, and the like), etc.

Remote locations represent a particular situation in which water having a suitable quality for human consumption and/or industrial use is necessary, but is often unavailable. For example, there is often the need for suitable water supplies in remote location for humanitarian efforts, for development projects (e.g., hydro-dam construction, renewable energy facilities construction, mining operations, etc), for military use, and the like. Although, sources of water are typically readily available in such remote locations (e.g., rivers, streams, lakes, oceans, wells, and the like), water from these sources is generally not suitable for human consumption without treatment and often requires treatment for certain industrial uses.

Treatment of water at remote locations and other locations with limited infrastructure presents several challenges. One such challenge is that there can be limited availability of electricity, which is required for operating essential water treatment equipment such as water pumps, heaters, etc, thereby making efficient use of available supplies of electricity beneficial. Another such challenge is that availability of supplies for required for water treatment equipment can be limited, such as due to the remote location itself and limitations in local transportation infrastructure, thereby making efficient use of available inventory of water treatment supplies beneficial. Another such challenge is that there can be limited facilities for storing treated water, thereby making on-demand supply of treated water beneficial. Therefore, water treatment systems and methods that are specifically configured for overcome these challenges are advantageous, desirable and useful.

### SUMMARY OF THE DISCLOSURE

Embodiments of the present invention are directed to water treatment systems and methods offering improved efficiency, longevity and versatility. More specifically, water treatment systems and methods configured in accordance with the present invention provide for dynamic bypass of one or more water treatment stages by at least a portion of water being treated. Dynamic bypass reduces the amount of work expended by water treatment system components to treat a given volume of water. Thus, by adjusting such work expended based on a target water quality, the water treatment system can conserve power, extend system up-time, reduce usage of system consumables, potentially remediate a fault in a treatment stage under certain conditions, avoid the need for designing different systems for different conditions, and support automation of system operation.

Dynamic bypass can be implemented through the use of system components that monitor (e.g., measure) water quality parameters at various points of treatment (e.g., water source, upstream of processing stage, downstream of processing stage, and the like), system components that allow all or a portion of the water being processed to bypass of one or more water treatment stages, and system components that allows all or a portion of water that has bypassed a particular water treatment stage to be recombined with all or a portion of water that has not bypassed the particular stage (e.g., reintroduced immediately following the particular water treatment stage or following a subsequent water treatment stage). The bypassed portion can entirely bypass a particular water treatment stage or can bypass the particular water treatment stage after being treated by the particular water treatment stage for a period of time less than a non-bypassed portion of the water is treated by the particular water treatment stage. In this regard, all or a portion of water flowing through a water treatment system can be subject to dynamic partial bypass functionality.

Advantageously, water treatment systems and methods configured in accordance with the present invention can utilize dynamic bypassing of one or more water treatment stages by all or a portion of a stream of water being treated to improve system efficiency, longevity and versatility. For example, to achieve a required or preferred water quality level by a particular water treatment stage, it may be desirable and possible to only treat a portion of a stream of water being treated and then recombine all or a portion of the treated water with all or a portion of the water that has bypassed that particular water treatment stage. An exemplary case in point is the fact that fresh water generally necessitates significantly less treatment than brackish or salty water (e.g., particularly with respect to certain water treatment stages (e.g., a reverse osmosis stage)) for achieving a desired or required (i.e., target) level of quality for human consumption and/or industrial use. In this manner, the such methods and systems offer versatility that results in substantial improvements in the efficiency by which power and water treatment system supplies required for achieving a target level of water quality are utilized and the efficiency by which on-demand supply of treated water is provided.

The dynamic control of bypass based on water quality at the input (and optionally output) of a stage provide functionality believed new. Dynamically adjusting operation of water treatment stages to meet the target water quality is not how most systems operate—instead they specify a minimum acceptable. Furthermore, partial bypass where some water is treated to a different degree than other and then recombined is conjectured to not exist but is not known for certain. Even if these options do exist, the conjecture is that they are not performed dynamically and automatically.

In one embodiment of the present invention, a method is performed by a system controller of a water treatment system. The method includes a plurality of operations. An operation is performed for assessing, in response to causing an initial volume of water to flow through one or more of a plurality of water treatment stages of the water treatment system, signal output of one or more water quality characterizing devices of the water treatment system to determine one or more water quality parameters characterizing an untreated condition of the water and to determine one or more treatment efficiency parameters for at least one of the water treatment stages. An operation is performed for determining, using the one or more water quality parameters and the one or more treatment efficiency parameters, an active version of a water treatment protocol under which a subsequent volume of the water are to be treated using one or more of the water treatment stages to achieve a target treated water quality in response to the subsequent volume being subjected to treatment by the one or more of the water treatment stages. An operation is performed for controlling a flow control structure of the water treatment system to subject the subsequent volume of the water to be treated by the water treatment stages in accordance with the active version of the water treatment protocol.

In another embodiment of the present invention, a non-transitory computer readable medium is provided for controlling treatment of water in a water treatment system. The non-transitory computer readable medium comprises instruction stored thereon, that when executed on at least one processor, perform the steps of a method. Such steps of the method in receiving, by the at least one processor, one or more water quality parameter signals from one or more water more water quality characterizing devices of the water treatment system, determining, by the at least one processor as a function of the one or more water quality parameter signals, at least one of a partial portion of water to be treated by a particular one or more of the water treatment stages and a partial portion of the water to bypass the particular one or more of the water treatment stages, and controlling, by the at least one processor, a flow control structure of the water treatment system to subject the partial portion of the water to be treated by the particular one or more of the water treatment stages to treatment by the water treatment stages and, in response to said treatment, to recombine at least a portion of water treated by the particular one or more of the water treatment stages with at least a portion of the water having bypassed the particular one or more of the water treatment stages. Each of the one or more water quality parameter signals correlates to a respective treatment effectiveness indicating parameter for a respective one of a plurality of water treatment stages of the water treatment system.

In another embodiment of the present invention, a water treatment system comprises a water treatment apparatus, one or more water quality characterizing devices, and a water treatment controller. The water treatment apparatus includes a plurality of water treatment stages interconnected by a flow control structure. The one or more water quality characterizing devices are coupled to the water treatment apparatus. Each of the water quality characterizing devices outputs one or more water quality parameter signals characterizing a treatment effect of one or more of the water treatment stages. A water treatment controller is coupled to the flow control structure and to the one or more water quality characterizing devices. The water treatment controller uses the one or more water quality parameter signals to determine at least one of a portion of water to be treated by a particular one or more of the water treatment stages and a portion of the water to bypass the particular one or more of the water treatment stages. The water treatment controller controls operation of the flow control structure to subject the portion of water to be treated by the particular one or more of the water treatment stages to treatment by the water treatment stages and, in response to such treatment, to recombine at least a portion of the water treated by the particular one or more of the water treatment stages with at least a portion of the water having bypassed the particular one or more of the water treatment stages.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a flow diagram view showing a method for treating water in accordance with an embodiment of the present invention.

FIG. 2 is a flow diagram view showing steps for calibrating water treatment stages in accordance with an embodiment of the present invention.

FIG. 3 is a flow diagram view showing steps for determining a water treatment protocol in accordance with an embodiment of the present invention.

FIG. 4 is a flow diagram view showing steps for controlling a flow control structure in accordance with an embodiment of the present invention.

FIG. 5 is a diagrammatic view showing a first embodiment of a water treatment system configured in accordance with the present invention.

FIG. 6 is a diagrammatic view showing a second embodiment of a water treatment system configured in accordance with the present invention.

### DETAILED DESCRIPTION

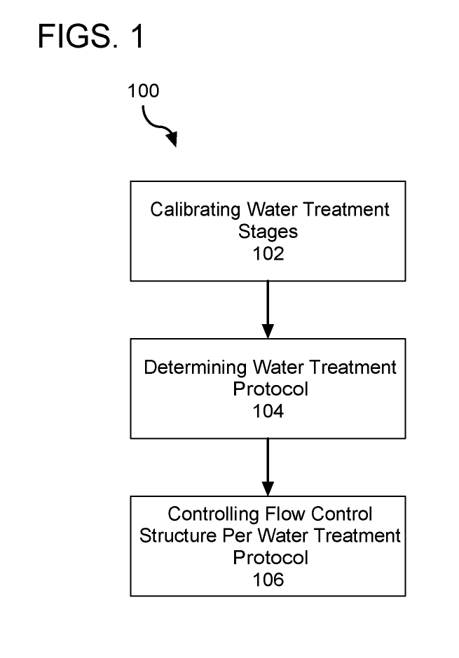

FIG. 1 shows a method 100 for treating water in accordance with an embodiment of the present invention. The method 100 can begin with an operation 102 for calibrating a plurality of water treatment stages in a water treatment system. In response to the calibration operation 102, an operation 104 is performed for determining a water treatment protocol based upon one or more calibration parameter values resulting from the calibration operation 102. Thereafter, an operation 106 is performed for controlling a flow control structure

As a skilled person will appreciate from the disclosures made herein, a key objective of treating water in accordance with an embodiment of the present invention (e.g., the method 100) is providing for improved efficiency, longevity and versatility in a water treatment system. As will be understood from the disclosures made herein, a water treatment system configured in accordance with the present invention can provide for dynamic bypass of one or more water treatment stages by at least a portion of water being treated. Dynamic bypass reduces the amount of work expended by water treatment system components to treat a given volume of water. Thus, by adjusting such work expended based on a target water quality, the water treatment system can conserve power, extend system up-time, reduce usage of system consumables, potentially remediate a fault in a treatment stage under certain conditions, avoid the need for designing different systems for different conditions, and support automation of system operation. In general, the method 100 can implement dynamic bypass through the use of system components that monitor (e.g., measure) water quality parameters at various points of treatment (e.g., water source, upstream of processing stage, downstream of processing stage, and the like), system components that allow all or a portion of the water being processed to bypass of one or more water treatment stages, and system components that allows all or a portion of water that has bypassed a particular water treatment stage to be recombined with all or a portion of water that has not bypassed the particular stage (e.g., reintroduced immediately following the particular water treatment stage or following a subsequent water treatment stage). The bypassed portion can entirely bypass a particular water treatment stage or can bypass the particular water treatment stage after being treated by the particular water treatment stage for a period of time less than a non-bypassed portion of the water is treated by the particular water treatment stage. In this regard, all or a portion of water flowing through a water treatment system can be subject to dynamic partial bypass functionality.

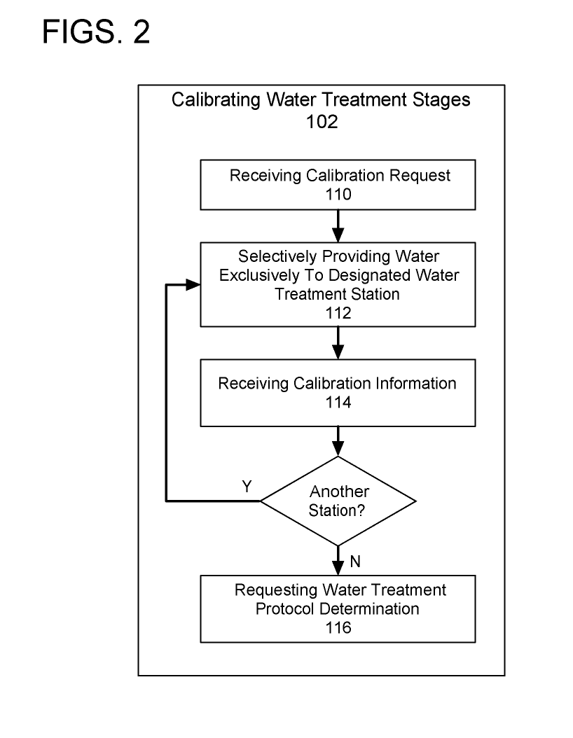

FIG. 2 shows an embodiment of steps in the operation for calibrating water treatment stages (e.g., the operation 102 in FIG. 1). As shown, the operation for calibrating the water treatment stages can begin with a step 110 for receiving a calibration request. For example, the calibration request can be manually issued or, as discussed below in greater detail with respect to the operation of controlling the flow control structure of the water treatment system, can be issued under system control (e.g., in response to a trigger condition identified by the water treatment system). In response to receiving the calibration request, a step 112 is performed for selectively providing water exclusively to a designated one of the plurality of water treatment stages, followed by a step 114 for receiving (e.g., storing) corresponding stage calibration information. It is disclosed herein that intake of water from a water supply providing water to be treated can be one of the plurality of water treatment stages. If calibration of another one of the water treatment stages is required or desired, the operation 102 returns to the step 112 for selectively providing water to a different one of the water treatment stages. Otherwise, the operation 102 continues with a step 116 for requesting water treatment protocol determination.

It is disclosed herein that the stage calibration information for a particular stage can include one or more calibration parameter values. For example, the stage calibration information for a particular stage can include a calibration parameter value for each one of a plurality of water quality parameter determining devices of a single (e.g., unitized and unified) water quality determining apparatus. Furthermore, as discussed below in greater detail with respect to embodiments of water treatment systems configured in accordance with the present invention, the ability to exclusively provide water to each water treatment stage allows for a simple water quality determining apparatus to be shared by all stages for calibration purposes and for monitoring quality of water treated by the system during active system operation.

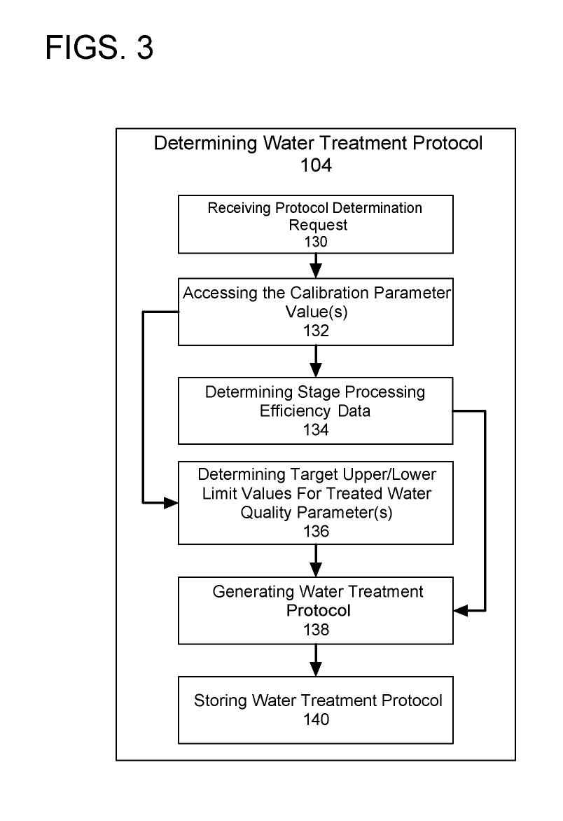

FIG. 3 shows an embodiment of determining a water treatment protocol in accordance with the present invention (e.g., the operation 104 in FIG. 1). As shown, the operation for determining the water treatment protocol can begin with a step 130 for receiving a protocol determination request. For example, the protocol determination request can be calibration request can be manually issued or can be issued under system control (e.g., in response to completion of calibration of one or more water treatment stages in a the stage calibration operation 102). In response to receiving the protocol determination request, a step 132 is performed for accessing the stage calibration information for each stage that has been calibrated (i.e., jointly referred to as the calibration data). After receiving the calibration data, a step 134 can be performed for determining stage processing efficiency information. For example, the calibration data can be used to derive a level of efficiency by which each stage can process the water (e.g., optimal amount of an element that the stage can remove from the water as provided from its source). This step is important in that the efficiency of a stage can be largely dependent on the quality of the water in an untreated state (e.g., full salt water compared to brackish water compared to fresh water). It is disclosed herein that determination of the processing efficiency information can alternatively or optionally be partially or fully performed during the calibration operation 102.

In conjunction with determining stage processing efficiency information, a step 136 is performed for determining target treated water quality upper and lower limits for the stage calibration information of one or more of the water treatment stages. Using the stage processing efficiency information and the target treated water quality upper and lower limits, a step 138 is performed for generating a protocol (i.e., water treatment protocol) by which the water treatment stages are operated and/or a manner in which water is supplied to the water treatment stages. For example, the water treatment protocol can dictate the amount of electrical energy supplied to a particular state (e.g., for heating the water), can dictate the partial portion of volume of water that bypasses a particular stage, can dictate the partial portion of volume of water that is supplied to a particular stage, and the like. Thereafter, a step 140 is performed for storing the water treatment protocol.

The water treatment protocol can be in the form of instructions. Such instructions are used to control the water treatment stages and/or a flow control structure through which the water is provided to the water treatment stages. In preferred embodiments, the instructions are accessibly from a non-transitory computer readable medium and are executable by a data processing device that is coupled to the water treatment stages and/or to the flow control structure.

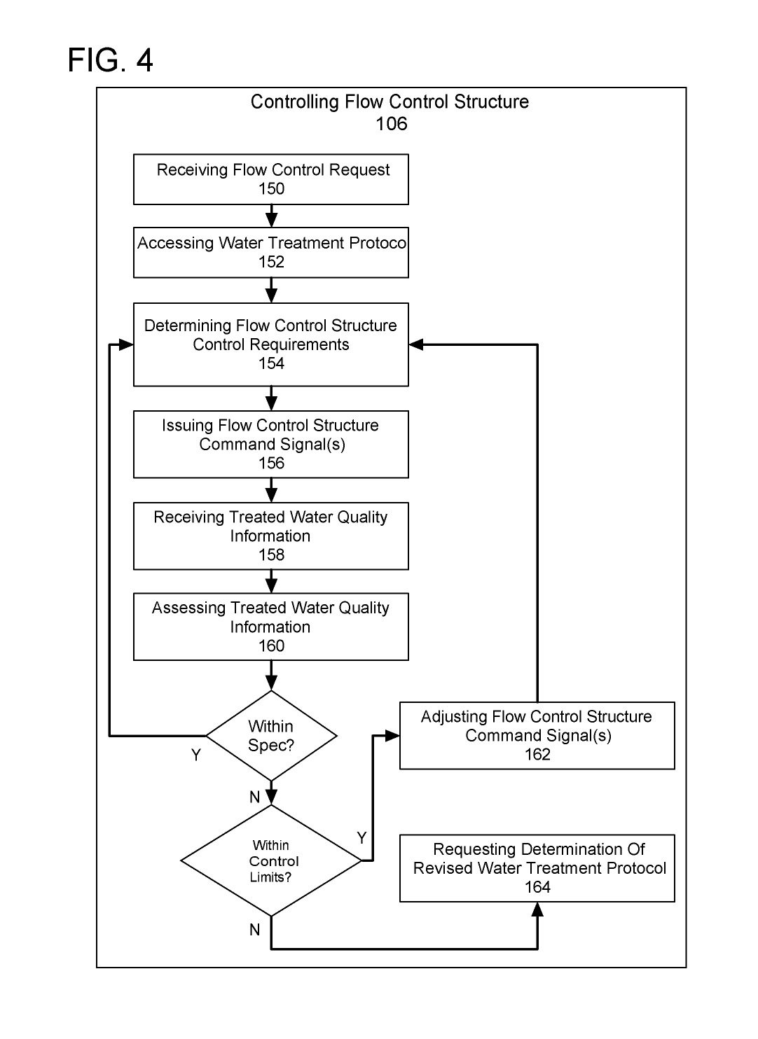

FIG. 4 shows an operation for controlling a flow control structure in accordance with an embodiment of the present invention (e.g., the operation 106 in FIG. 1). As shown, the operation for controlling a flow control structure can begin with a step 150 for receiving a flow control request. In response to receiving the flow control request, a step 152 is performed for accessing a water control protocol (i.e., the active version of the water treatment protocol), followed by a step 154 for determining control requirements for the flow control structure (i.e., flow control structure control requirements) as defined by the water treatment protocol. For example, the water treatment protocol can be used to determine a control parameter value (e.g., degree of valve opening) required for causing a flow control valve to bypass a prescribed partial portion of water around a particular water treatment station. A step 156 is performed for issuing to the flow control structure a flow control structure command signal derived from the flow control structure control requirements. The flow control structure command signal is a signal that causes the flow control structure to achieve a corresponding control parameter value (e.g., pulse width signal or digital signal that causes a valve to have a particular degree of valve opening).

In response to water being treated by the water treatment stages as dictated by the flow control structure command signal, a step 158 is performed for receiving treated water quality information, which may consist of one or more treated water quality parameter values that are outputted by a water quality determining apparatus of the water treatment system (or water quality determining devices thereof). A step 160 is performed for assessing the treated water quality information to determine if the treated water quality is within specification (e.g., relative to the stage processing efficiencies, water treatment protocol, and the like). If the treated water quality is within specification, the operation for controlling the flow control structure continues at the step 156 for issuing the flow control structure command signal. If the treated water quality is not within specification but within known or approximated control limits of the water treatment control system, the operation for controlling the flow control structure continues at a step 162 for adjusting the flow control structure command signal accordingly (e.g., relative to the stage processing efficiencies, water treatment protocol, and the like). Otherwise, the operation for controlling the flow control structure continues at a step 164 for requesting determination of a revised water treatment protocol such as by the method 100 returning to the operation 104 for determining the water treatment protocol. Advantageously, in view of the flow control capabilities of a water treatment system configured in accordance with embodiments of the present invention, the revised version of the water treatment protocol (i.e., a modified water treatment protocol) can includes treatment of the water by the at least one water treatment stage that was inactive under the previous version of the water treatment protocol

The objective of controlling the flow control structure is to generate water having a treated water quality dictated by the water treatment protocol that was derived from information generated by calibration of the water treatment stages. Notably and advantageously, such objective of controlling the flow control structure in accordance with the water treatment protocol (and any signal feedback loops) is more specifically to maintain the treated water quality within at the lower limit of the treated water quality upper/lower limit range. Conventionally, this objective is exactly the opposite, which is to optimize the degree of treatment within water quality range or capability of the water treatment system. However, embodiments of the present invention are directed to treating water in a manner that optimizes offers improved system efficiency and system resource longevity, at the expense of achieving optimized treated water quality as it relates to the underlying water treatment capabilities of the water treatment system. Put differently, the a water treatment system in accordance with an embodiment of the present invention has the capability to provide treated water of a much better quality, but such better quality requires the water treatment system to consume more power, exhibit increased down-time, increases usage of system consumables (e.g., filters and depletable elements). Thus, by targeting the lower limit of the treated water quality range, power consumption is reduced, system up-time is increased, usage of system consumables is reduced, and the like.

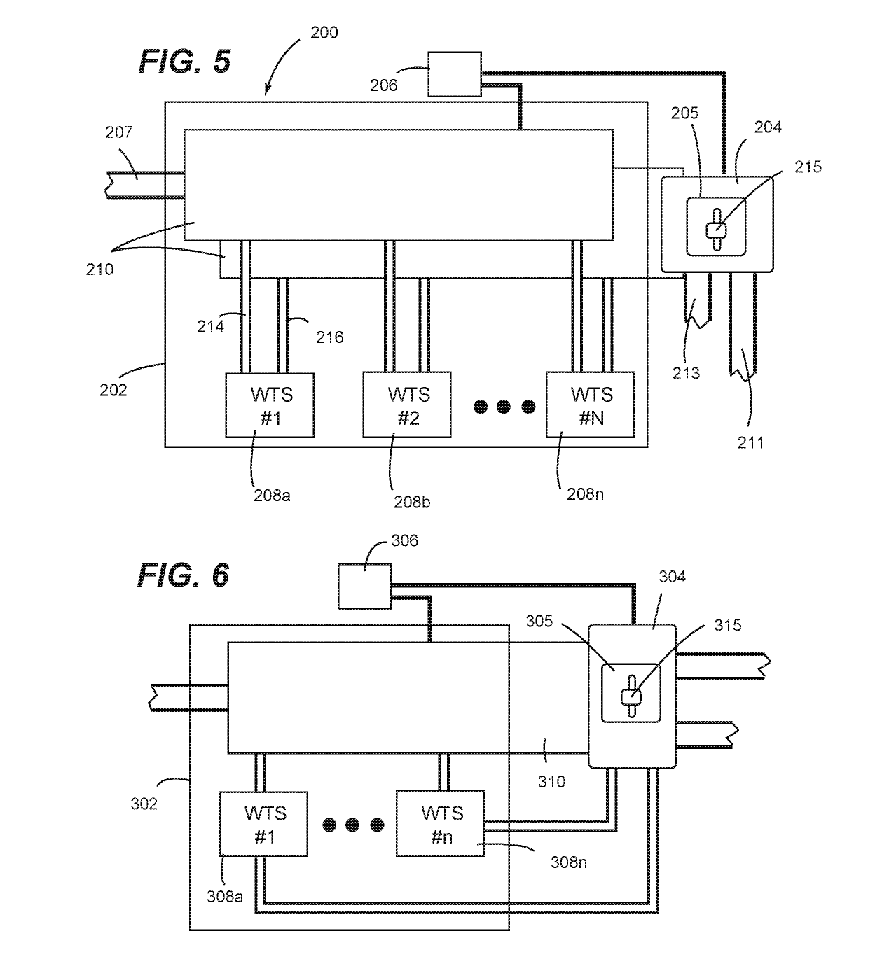

FIG. 5 shows first embodiment of a water treatment system configured in accordance with the present invention (water treatment system 200). The water treatment system 200 includes a water treatment apparatus 202, a water discharge structure 204, and a water treatment controller 206. The water treatment apparatus 202 includes a plurality of water treatment stages 208a-208n interconnected by a flow control structure 210. The water discharge structure 204 is coupled to the water treatment apparatus 202 for receiving water from the flow control structure 210. The water treatment controller 206 is coupled to the flow control structure 210 for providing control information (e.g., signals) thereto and is coupled to a water quality determining apparatus 205 of the water discharge structure 204 for receiving treated water quality information (e.g., water quality sensor output signal(s)) therefrom.

The water discharge structure 204 and the flow control structure 210 are jointly configured for enabling selective discharge of water in response to treatment of the water by one or more of the water treatment stages 208a-208n and in response to calibration of the water treatment stages 208a-208n. The flow control structure 210 has a water supply inlet 207 through which water to be treated by the water treatment system 100 is received. The water treatment stages 208a-208n each have a water inlet 214 thereof and a water outlet 216 thereof connected to the flow control structure 210 for allowing water to be treated by each one of the water treatment stations 208a-208n to be provided thereto. The water discharge structure 204 has a treated water discharge 211 through which treated water is discharged from the water treatment system 100 and a dump discharge outlet 213 through which untreated, partially treated and/or fully treated water used for stage calibration is discharged from the water treatment system 100. Advantageously, the flow control structure 210 enables water to be selectively and exclusively provided to each one of the water treatment stages 208a-208n and to be selectively routed between two or more of the water treatment stages 208a-208n in a circuitous path. To this end, the water discharge structure 204 and the flow control structure 210 can each include flow conduit and valve devices that provide for such selective and exclusive water flow capabilities.

One reason for these capabilities being advantageous is that being able to selectively and exclusively provided to each one of the water treatment stages 208a-208n allows for independent calibration of each one of the water treatment stages 208a-208n, with the water that is used for such calibration (i.e., an initial volume of water to be treated under a particular water treatment protocol) to be discharged via the water discharge structure 204 through the dump discharge outlet 213 thereof. Another reason for these capabilities being advantageous is that enabling water to be selectively routed between two or more of the water treatment stages 208a-208n in a circuitous path provides for versatility in the manner in which water is treated (i.e., a subsequent volume of water to be treated under the particular water treatment protocol). For example, water can be treated in accordance with a first circuitous path (e.g., defined by a first combination of water treatment stages) and then, as desired or necessary, treated in accordance with a second circuitous path (e.g., defined by a second combination of water treatment stages different than the first combination of water treatment stages).

The water quality determining apparatus 205 is configured for sampling water provided thereto from the flow control structure 210, generating treated water quality information, and outputting the treated water quality information to the water treatment controller 206 and/or other internal or external information processing apparatus. In at least one embodiment, the water quality determining apparatus 205 includes one or more water quality characterizing devices 215 for outputting water quality information for water provided thereto from the water treatment structure 210. Examples of such classes of water quality characterizing devices include, but are not limited to, sensors that measure a secondary water parameter to infer or derive a signal characterizing a primary water quality parameter (e.g., measuring conductivity of the water to infer or derive a magnitude of one or more components or compositions in the water (e.g., salinity)), sensors that quantitatively characterize turbidity (i.e., how clear the water is and thus relative amounts of components or compositions in the water that are detected though the manner in which they affect impact light transmission through the water), sensors that detect specific chemical components/compositions, sensors that determine thermal properties (e.g., heat transfer capability) of the water, and the like. Water treatment systems configured in accordance with embodiments of the present invention are not unnecessarily limited to implementation any particular type or class of water quality characterizing device(s)

In view of the joint capability of the water discharge structure 204 and the flow control structure 210 to selectively and exclusively provide water to be treated to each one of the water treatment stages 208a-208n for allowing independent calibration of each one of the water treatment stages 208a-208n, the water quality determining apparatus 205 can be implemented as a single unified water quality determining unit located downstream of water treatment stages for which treated water quality information is desired or required (e.g., such as for stage calibration purposes and/or treated water quality monitoring purposes). Such a unified water quality determining unit is advantageous from a cost standpoint and from a physical packaging standpoint. However, it is disclosed herein that the water treatment systems configured in accordance with embodiments of the present invention can have one or more water quality determining devices located at various location within the flow control structure 210 and/or otherwise directly in combination with one or more of the water treatment stages 208a-208n (e.g., using readings from the entry to the next stage as the output from the prior stage).

It is disclosed herein that water treatment systems configured in accordance with embodiments of the present invention are not unnecessarily limited to any particular types or classes of water treatment stages 208a-208n. Water treatment stages can be selected and implemented based on an particular application or intended/expected/potential source or water to be treated. One example of a water treatment stage is a pre-filter (e.g., a screen or a cartridge with sand, diatomaceous earth (DE) etc) that removes physical debris. Another example a water treatment stage is a polish filter (e.g., usually some sort of carbon filter containing activated carbon). Another example a water treatment stage is ultra filtration (UF) that is in effect a fine-particle filter that is useful in removing large molecules, dirt, etc not removed by a pre-filter. Another example a water treatment stage is reverse osmosis (RO) that is generally used for removing salt from salty or brackish water (i.e., reducing a salinity level). Another example a water treatment stage is ultra violet (UV) that is generally used to disinfect (e.g., to reduce dependence on chlorine) without leaving any by-product of UV in the treated water. Another example a water treatment stage is ozone in which ozone (i.e., O3) is added to the water to disinfect by breaking down into Oxygen (O2) so no byproduct of the applied ozone is left in the treated water. Another example a water treatment stage is distillation, which involved boiling of the water and then cool the resulting steam back into water, which removes a lot of undesired element/compositions from the water. Boiling also is used to extract undesirable elements/compositions by converting them to gasses and by killing many undesirable organisms. Unlike distillation, the water that is kept is what does not boil off. Another example a water treatment stage is ion-exchange, which replaces an unwanted ion with a desired (e.g., safer) one. Another example a water treatment stage is radioactivity in which the water is irradiated to eliminate unwanted/undesirable elements, compositions, and organisms. In preferred embodiments, water quality determining apparatus 205 (e.g., water quality characterizing sensors thereof) is configured dependent upon the available water treatment stages in a water treatment system. Uptake of water from its source is yet another example of a water treatment stage.

The water treatment controller 206 uses a water treatment protocol and/or information (e.g., in the form of signals) received from the water quality determining apparatus 205 (e.g., water stage calibration information and/or treated water quality information) to determine the manner in which water is to be routed by the flow control structure 210 to the water treatment stations 208a-208n and issues corresponding actuation signals to the flow control structure 210. In preferred embodiments, the water treatment controller 206 uses a water treatment protocol and/or information (e.g., in the form of signals) received from the water quality determining apparatus 205 to determine any one or more of: a partial portion of water flowing through the flow control structure 210 that is to be treated by a particular one or more of the water treatment stages, a partial portion of water flowing through the flow control structure 210 that is to bypass the particular one or more of the water treatment stages, a portion and location in the water flow circuit at which water that has been bypassed is recombined with water that has not been bypassed. For example, the water treatment controller 206 can implement the flow control structure controlling operation discussed above in reference to FIGS. 1 and 4. Such partial portion bypass can be implemented in a fixed manner or in a variable manner such as in response to water quality feedback signals provided by one of more quality determining devices that are distributed through the flow control structure 210 and/or in combination with one or more of the water treatment stations 208a-208n. A unique aspect of water treatment controllers configured in accordance with embodiments of the present invention is that they implement partial portion bypassing of water in a manner that does not inhibit a target treated water quality from being achieved.

The water treatment controller 206 can also be configured for implementing calibration of the water treatment stations 208a-208n. More specifically, the water treatment controller 206 can use information received from the water quality determining apparatus 205 to determine an efficiency by which one or more of the water treatment stations 208a-208n can treat water being provided to the water treatment system 200. To this end, for example, the water treatment controller 206 can be configured for implementing the calibration operation discussed above in reference to FIGS. 1 and 2. Moreover, though use of information received from the water quality determining apparatus 205, the water treatment controller 206 can be configured for determining water treatment protocols such as by the water treatment protocol determining operation discussed above in reference to FIGS. 1 and 3.

FIG. 6 shows second embodiment of a water treatment system configured in accordance with the present invention (water treatment system 300). The water treatment system 300 includes a water treatment apparatus 302, a water discharge structure 304, and a water treatment controller 306. The water treatment apparatus 302 includes a plurality of water treatment stages 308a-308n interconnected by a flow control structure 310. The water discharge structure 304 is coupled to the water treatment apparatus 302 for receiving water from the flow control structure 310 The water treatment controller 306 is coupled to the flow control structure 310 for providing control information (e.g., signals) thereto and is coupled to a water quality determining apparatus 305 of the water discharge structure 304 for receiving treated water quality information (e.g., water quality sensor output signal(s)) therefrom. The water treatment system 300 functions generally similar to the water treatment system 300 discussed above in reference to FIG. 5, but with the following differences. The configuration of the flow control structure 310 and water flow routing of the water treatment stages 308a-308n provides a fixed water flow circuit. While partial portions of water provided to each one of the water treatment stages 308a-308n can be adjusted, the configuration of the circuit through which the water flows cannot otherwise be changed.

It is disclosed herein that a water treatment controller configured in accordance with an embodiment of the present invention can be a data processing apparatus that implements various operations was commanded to by instructions. For example, the water treatment controller can include one or more data processing devices that execute instruction accessed by the data processing device from a non-transitory computer readable medium. In preferred embodiments, such instructions are configured to provide for water treatment stage calibration, water treatment protocol determination, and flow control structure controlling (e.g., including discharge structure control). Although water treatment systems in accordance with the present invention are preferably implemented using electronic means of control, it is disclose herein that control functionality can be implemented using mechanical means.

In view of the disclosures made herein, a skilled person will appreciate man differentiators between water treatment systems configured in accordance with embodiments of the present invention. One such differentiator is the ability to electronically discharge waste water separately from a treated water discharge outlet. Such waste water discharge allows for calibration on demand as water used during calibration can be selectively discharged, provides for additional protection against transients (e.g., temporarily bad water can be selectively discharged rather than shutting the whole system down), provides for combining of constant monitoring and the ability to selectively dump water, allows any water treatment stage to be bypassed, provides the ability to adjust to gradual changes in input water quality or filter effectiveness (e.g. temperature change) by adjusting the water treatment strategy, and provides the ability to adjust to sudden changes in input water or filter effectiveness by initiating selectively calibration, provides for partial fault recovery (e.g., if the UF fails, the system can temporarily use RO or 100% RO processing instead). Another such differentiator is the longevity of system resources (e.g., through reduced utilization and also the ability to use optionally use alternate water treatment stage options in place of another (e.g., if the UF fails, the system can temporarily use RO or 100% RO processing instead). Still another such differentiator is efficiency by which the water treatment system operate due to, for example, reduced energy usage by completely or partially skipping more energy intensive water treatment stages. Still a further such differentiator is the versatility provided by a single water treatment system that can be implemented in an application specific manner such as for a range of input water with automatic adjustment to assure proper operation (e.g., through onsite calibration and water treatment protocol determination).

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. A method performed by a system controller of a water treatment system, the method comprising:
assessing, in response to causing an initial volume of water to flow through one or more of a plurality of water treatment stages of the water treatment system, signal output of one or more water quality characterizing devices of the water treatment system to determine one or more water quality parameters characterizing an untreated condition of the water and to determine one or more treatment efficiency parameters for at least one of the water treatment stages;
determining, using the one or more water quality parameters and the one or more treatment efficiency parameters, an active version of a water treatment protocol under which a subsequent volume of the water are to be treated using one or more of the water treatment stages to achieve a target treated water quality in response to the subsequent volume being subjected to treatment by the one or more of the water treatment stages; and
controlling a flow control structure of the water treatment system to subject the subsequent volume of the water to be treated by the water treatment stages in accordance with the active version of the water treatment protocol.

2. The method of claim 1 wherein assessing the signal output includes:
issuing an actuation signal to the flow control structure for causing each one of the water treatment stages to have a portion of the water to be treated to be exclusively provided thereto; and
in response to such portion of the water to be treated being provided exclusively to a particular one of the water treatment stages, storing one or more water quality parameters received from the one or more water quality devices characterizing a water quality of such portion of the water to be treated being provided exclusively to the particular one of the water treatment stages.

3. The method of claim 1 wherein controlling the flow control structure to subject the subsequent volume of the water to be treated by the water treatment stages in accordance with the active version of the water treatment protocol includes issuing an actuation signal to the flow control structure for causing a prescribed partial portion of the subsequent volume of the water to be provided to a particular one of the water treatment stages and for causing a remaining portion of the subsequent volume of the water to bypass a particular one of the water treatment stages.

4. The method of claim 1 wherein the active version of the water treatment protocol defines at least one of:
a partial portion of the subsequent volume of water to be treated by a particular one or more of the water treatment stages; and
a partial portion of the water to bypass the particular one or more of the water treatment stages.

5. The method of claim 1 wherein determining the active version of the water treatment protocol includes:
determining a particular one of the water treatment stages by which only a partial portion of the subsequent volume of water can be treated without inhibiting a target treated water quality for the subsequent volume of water from being achieved; and
determining a relative magnitude of the partial portion.

6. The method of claim 1, further comprising:
monitoring signal output of the one or more water quality characterizing devices during treatment of the subsequent volume of the water;
determining a modified version of the water treatment protocol in response to detecting a water quality parameter requiring utilization of at least one of the water treatment stages that is inactive under the active version of the water treatment protocol, wherein the modified version of the water treatment protocol includes treatment of the water by the at least one of the water treatment stages that is inactive under the active version of the water treatment protocol; and
updating the active version of the water treatment protocol to be the modified version of the water treatment protocol.

7. The method of claim 1 wherein:
the active version of the water treatment protocol defines a first partial portion of the subsequent volume of water to be treated by a first one of the water treatment stages and a second partial portion of the subsequent volume of water that is to be treated by a second one of the water treatment stages prior to being recombined with the first partial portion of the subsequent volume of water; and
controlling the flow control structure includes directing the first partial portion of the subsequent volume of water to the first one of the water treatment stages, directing the second partial portion of the subsequent volume of water to the second one of the water treatment stages, recombining the first and second partial portions of the subsequent volume of water after the first and second partial portions of the subsequent volume of water are treated by the respective one of the water treatment stages.

8. A non-transitory computer readable medium for controlling treatment of water in a water treatment system, the non-transitory computer readable medium comprising instruction stored thereon, that when executed on at least one processor, perform the steps of:
receiving, by the at least one processor, one or more water quality parameter signals from one or more water more water quality characterizing devices of the water treatment system, wherein each of the one or more water quality parameter signals correlates to a respective treatment effectiveness indicating parameter for a respective one of a plurality of water treatment stages of the water treatment system;
determining, by the at least one processor as a function of the one or more water quality parameter signals, at least one of a partial portion of water to be treated by a particular one or more of the water treatment stages and a partial portion of the water to bypass the particular one or more of the water treatment stages; and
controlling, by the at least one processor, a flow control structure of the water treatment system to subject the partial portion of the water to be treated by the particular one or more of the water treatment stages to treatment by the water treatment stages and, in response to said treatment, to recombine at least a portion of water treated by the particular one or more of the water treatment stages with at least a portion of the water having bypassed the particular one or more of the water treatment stages.

9. The non-transitory computer readable medium of claim 8 wherein receiving the one or more water quality parameter signals includes:
issuing an actuation signal to the flow control structure for causing each one of the water treatment stages to have a portion of the water to be treated to be exclusively provided thereto; and
in response to such portion of the water to be treated being provided exclusively to a particular one of the water treatment stages, storing one or more water quality parameters received from the one or more water quality devices characterizing a water quality of such portion of the water to be treated being provided exclusively to the particular one of the water treatment stages.

10. The non-transitory computer readable medium of claim 9 wherein:
the one or more water quality characterizing devices are integrated into a unified water quality characterizing apparatus;
the unified water quality characterizing apparatus is located downstream of the water treatment stages; and
storing the one or more water quality parameters for the particular one of the water treatment stages includes associating the particular one of the water treatment stages with the one or more water quality parameters generated in response to the water to be treated being provided exclusively to the particular one of the water treatment stages.

11. The non-transitory computer readable medium of claim 8 wherein controlling the flow control structure to subject the partial portion of the water to be treated by the particular one or more of the water treatment stages includes issuing an actuation signal to the flow control structure for causing the partial portion of the water to be treated to be provided to the particular one of the water treatment stages and for causing a remaining portion of the water to be treated to bypass the particular one of the water treatment stages.

12. The non-transitory computer readable medium of claim 8 wherein determining at least one of the partial portion of water to be treated by a particular one or more of the water treatment stages and a partial portion of the water to bypass the particular one or more of the water treatment stages includes deriving, as a function of the respective treatment effectiveness indicating parameter associated with the particular one of the water treatment stages, a limit for the amount of water to be treated that can bypass the particular one or more of the water treatment stages without inhibiting a target fully treated water quality therefor being achieved.

13. The non-transitory computer readable medium of claim 8, wherein in combination with controlling the flow control structure:
monitoring signal output of the one or more water quality characterizing devices during treatment of the treatment of the water;
in response to detecting a particular one of the water treatment stages in which a partial portion of the water to be treated is being subjected to treatment thereby, commanding the flow control structure to subject an increased portion of the water to the particular one of the water treatment stages.

14. A water treatment system, comprising:
a water treatment apparatus including a plurality of water treatment stages interconnected by a flow control structure;
one or more water quality characterizing devices coupled to the water treatment apparatus, wherein each of the water quality characterizing devices outputs one or more water quality parameter signals characterizing a treatment effect of one or more of the water treatment stages; and
a water treatment controller coupled to the flow control structure and to the one or more water quality characterizing devices, wherein the water treatment controller uses the one or more water quality parameter signals to determine at least one of a portion of water to be treated by a particular one or more of the water treatment stages and a portion of the water to bypass the particular one or more of the water treatment stages, and wherein the water treatment controller controls operation of the flow control structure to subject the portion of water to be treated by the particular one or more of the water treatment stages to treatment by the water treatment stages and, in response to said treatment, to recombine at least a portion of the water treated by the particular one or more of the water treatment stages with at least a portion of the water having bypassed the particular one or more of the water treatment stages.

15. The water treatment system of claim 14 wherein the flow control structure is connected to the water treatment stages for enabling selective bypass of any of the water treatment stages by all or a portion of water being treated by the water treatment apparatus.

16. The water treatment system of claim 15 wherein:
the one or more water quality characterizing devices are integrated into a unified water quality characterizing apparatus;
the unified water quality characterizing apparatus is located downstream of the water treatment stages;
the flow control structure is connected to the unified water quality characterizing apparatus;
the flow control structure is responsive to actuation signals received from the water treatment controller; and
the water treatment controller issues actuation signals to the flow control structure for causing each one of the water treatment stages to have a portion of the water to be treated to be exclusively provided thereto.

17. The water treatment system of claim 16 wherein the water treatment controller, in response to such portion of the water to be treated being exclusively provided to a particular one of the water treatment stages:
stores one or more water quality parameters received from the unified water quality characterizing apparatus; and
associates the particular one of the water treatment stages with the one or more water quality parameters generated in response to the water to be treated being provided exclusively to the particular one of the water treatment stages.

18. The water treatment system of claim 14 wherein:
the water treatment controller issues, to the flow control structure, actuation signals derived as a function of an active version of a water treatment protocol for causing the water to be treated by the water treatment stages in accordance with the active version of the water treatment protocol; and
the water treatment protocol defines at least one of a partial portion of the water to be treated by a particular one or more of the water treatment stages and a partial portion of the water to bypass the particular one or more of the water treatment stages.

19. The water treatment system of claim 18 wherein the water treatment controller determines the water treatment protocol by determining a particular one of the water treatment stages by which only a partial portion of the water can be treated without inhibiting a target treated water quality being achieved and determining a relative magnitude of the partial portion.

20. The water treatment system of claim 18 wherein the water treatment controller:
monitors signal output of the one or more water quality characterizing devices during treatment of the subsequent volume of the water;
determines a modified version of the water treatment protocol in response to detecting a water quality parameter requiring utilization of at least one of the water treatment stages that is inactive under the active version of the water treatment protocol, wherein the modified version of the water treatment protocol includes treatment of the water by the at least one of the water treatment stages that is inactive under the active version of the water treatment protocol; and
updates the active version of the water treatment protocol to be the modified version of the water treatment protocol.
